(19) United States
(12) Patent Application Publication
(10) Pub. No.: US 2026/0065491 A1
(43) Pub. Date: Mar. 5, 2026

(54) INFORMATION PROCESSING DEVICE

(71) Applicant: Panasonic Automotive Systems Co., Ltd., Kanagawa (JP)

(72) Inventor: Atsushi HIRAI, Tokyo To (JP)

(73) Assignee: Panasonic Automotive Systems Co., Ltd., Kanagawa (JP)

(21) Appl. No.: 19/268,631

(22) Filed: Jul. 14, 2025

(30) Foreign Application Priority Data
Aug. 30, 2024 (JP) 2024-149841

(51) Int. Cl. G06T 7/246; G06T 7/00; G06T 7/33

(52) U.S. Cl. CPC G06T 7/246; G06T 7/33; G06T 7/97; G06T 2207/20212; G06T 2207/30196

(57) ABSTRACT

In an information processing device, a processor acquires a first image including a body of a user captured by a first camera. The processor acquires a second image including a wrist of the user captured by a second camera. The processor generates a third image including the body and the wrist of the user by combining the first image and the second image. The processor determines a plurality of first feature points corresponding to the body of the user from the third image. The processor acquires a fourth image including a hand of the user based on a third feature point corresponding to the wrist of the user. The processor determines a plurality of second feature points corresponding to the hand of the user from the fourth image. The processor detects a motion of the hand of the user based on the plurality of second feature points.

### CROSS-REFERENCE TO RELATED APPLICATIONS

This application is based upon and claims the benefit of priority from Japanese Patent Application No. 2024-149841, filed on Aug. 30, 2024, the entire contents of which are incorporated herein by reference.

### FIELD

Embodiments described herein relate generally to an information processing device, an information processing system, an information processing method, and a recording medium.

### BACKGROUND

Conventionally, there are various devices that detect a motion of a hand of a user and perform motion control according to the detected motion of the hand of the user (see, for example, JP 2024-34419 A). Regarding an operation target, such as a monitor display that a user cannot reach or an operation device with which a user in a vehicle points to an object outside the vehicle, there is a device enabling a user to change contents displayed on the operation device in accordance with a motion of a hand of the user without directly touching the operation device.

In the technology described above, for detecting the motion of the hand of the user, there is a case where an image captured by a camera is acquired, the body and the hand of the user are determined from the acquired image, and the motion of the hand of the user is detected based on the direction at which the determined hand points.

However, the camera installed in the vehicle interior cannot capture both the body and the hand of the user within the angle of view of the camera, and there is a case where the acquired image does not include the body and the hand of the user. Therefore, in the processing of detecting the motion of the hand of the user, there is a case where the body and the hand of the user cannot be determined from the acquired image, and the motion of the hand of the user cannot be detected.

Therefore, there is a need for improving accuracy of detecting a motion of a hand of a user.

### SUMMARY

An information processing device according to one aspect of the present disclosure includes a memory in which a computer program is stored and a processor coupled to the memory. The processor is configured to perform processing by executing the computer program. The processing includes acquiring a first image and a second image. The first image includes a body of a user captured by a first camera. The second image includes a wrist of the user captured by a second camera. The processing includes generating a third image including the body and the wrist of the user by combining the first image and the second image. The processing includes determining a plurality of first feature points corresponding to the body of the user from the third image. The processing includes acquiring a fourth image including a hand of the user based on a third feature point corresponding to the wrist of the user. The processing includes determining a plurality of second feature points corresponding to the hand of the user from the fourth image. The processing includes detecting a motion of the hand of the user based on the plurality of second feature points.

### BRIEF DESCRIPTION OF THE DRAWINGS

FIG. 1 is a schematic diagram illustrating an example of an information processing device;

FIG. 2 is a schematic diagram for explaining processing of the information processing device;

FIG. 3 is a schematic diagram for explaining arrangement of a sensor according to a first comparative example;

FIG. 4 is a schematic diagram for explaining arrangement of a sensor according to a first embodiment;

FIG. 5 is a diagram illustrating a schematic configuration of an information system including a control device that is an information processing device according to the first embodiment;

FIG. 6 is a schematic diagram for explaining processing of the control device according to the first embodiment;

FIG. 7 is a schematic diagram for explaining processing of the control device according to the first embodiment;

FIG. 8 is a schematic diagram for explaining processing of the control device according to the first embodiment;

FIG. 9 is a schematic diagram for explaining processing of the control device according to the first embodiment;

FIG. 10 is a flowchart illustrating a processing procedure of the control device according to the first embodiment;

FIG. 11 is a diagram illustrating a schematic configuration of an information system including a control device that is an information processing device according to a second embodiment;

FIG. 12 is a schematic diagram for explaining processing of the control device according to the second embodiment;

FIG. 13 is a flowchart illustrating a processing procedure of the control device according to the second embodiment;

FIG. 14 is a schematic diagram for explaining processing of a control device according to a first modification;

FIG. 15 is a schematic diagram for explaining processing of a control device according to a second modification;

FIG. 16 is a schematic diagram for explaining processing of a control device according to a third modification;

FIG. 17 is a schematic diagram for explaining processing of a control device according to a third embodiment;

FIG. 18 is a diagram illustrating a schematic configuration of an information system including a control device that is an information processing device according to a fourth embodiment;

FIG. 19 is a schematic diagram for explaining processing of the control device according to the fourth embodiment;

FIG. 20 is a flowchart illustrating a processing procedure of the control device according to the fourth embodiment;

FIG. 21 is a schematic diagram for explaining arrangement of a sensor according to a fifth embodiment;

FIG. 22 is a schematic diagram for explaining arrangement of the sensor according to the fifth embodiment;

FIG. 23 is a schematic diagram for explaining the contents of processing of a control device according to the fifth embodiment;

FIG. 24 is a schematic diagram for explaining arrangement of a sensor according to a fifth modification;

FIG. 25 is a schematic diagram for explaining the contents of processing of the control device according to a fifth modification;

FIG. 26 is a schematic diagram for explaining arrangement of a sensor according to a sixth modification;

FIG. 27 is a schematic diagram for explaining the contents of processing of a control device according to the sixth modification;

FIG. 28 is a diagram illustrating a schematic configuration of an information system including a control device that is an information processing device according to a sixth embodiment;

FIG. 29 is a schematic diagram for explaining the contents of processing of the control device according to the sixth embodiment; and

FIG. 30 is a flowchart illustrating a processing procedure of the control device according to the sixth embodiment.

### DETAILED DESCRIPTION

Hereinafter, an embodiment of an information processing device according to the present disclosure will be described with reference to the drawings.

### First Embodiment

Before describing an information processing device according to the first embodiment, a device that operates based on a motion of a hand of a user will be described.

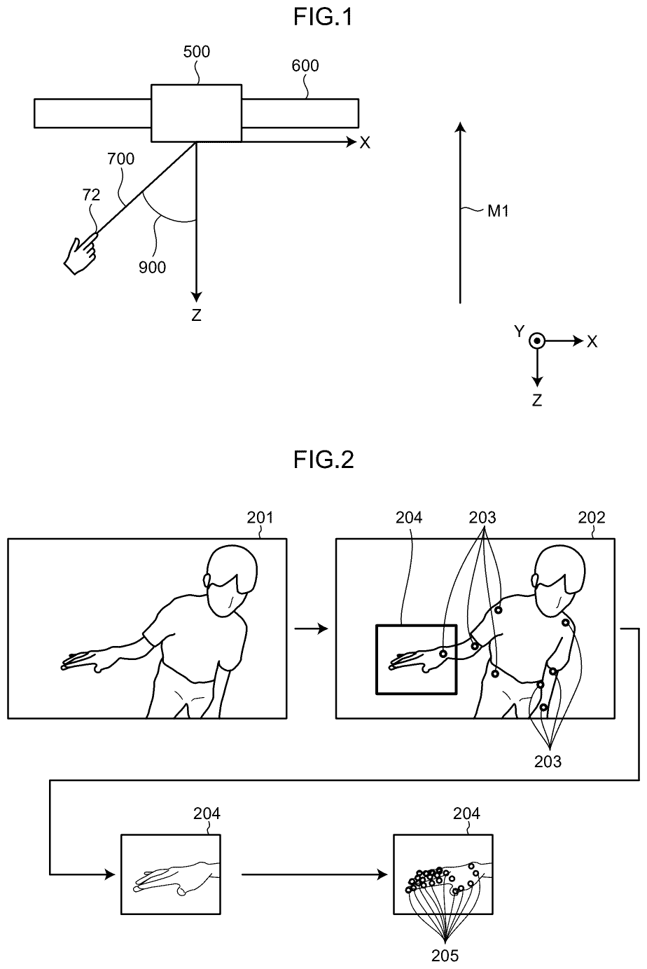

FIG. 1 is a schematic diagram illustrating an example of the information processing device. FIG. 1 illustrates an example of the information processing device that operates based on a motion of a hand of a user. The information processing device includes a sensor 500 and an operation device 600. The sensor 500 is, for example, a camera. The sensor 500 captures an image of the user who is an operator. The user has an arm. In the present disclosure, it is assumed that the arm includes not only the upper arm and the forearm but also the hand. The hand also includes a fingertip 72. The operation device 600 is, for example, a display device such as a display installed in a vehicle. The information processing device controls data displayed by the operation device 600 based on the position of user's fingertip 72.

Moreover, for example, in a case where the user points to a building outside the vehicle from the inside of the vehicle, the information processing device performs control such that the operation device 600 displays a direction of the object pointed based on the position of the user's fingertip 72. The object pointed by the user's fingertip 72 includes an object such as the operation device 600 or a building outside the vehicle.

In addition, the information processing device calculates an angle for receiving an operation on a device. Specifically, the information processing device calculates an angle 900 indicating an angle formed by a traveling direction M1 of the vehicle and an angle line 700 where the user's fingertip 72 points to the operation device 600 on an XZ plane.

In FIG. 1 and the drawings relating to the operation device 600 described below, an X axis, a Y axis, and a Z axis orthogonal to each other respectively mean a left-right direction, a vertical direction, and a front-rear direction of the operation device 600. In the following description, when simply described as the X direction, the Y direction, or the Z direction, the X direction, the Y direction, and the Z direction are axial directions, and include two opposite directions.

In addition, the positive direction of the X axis indicates one direction from the left side to the right side. The positive direction of the Y axis indicates one direction from the lower side to the upper side. The positive direction of the Z axis indicates one direction from the front side to the rear side. The negative direction of the X axis indicates one direction from the right side to the left side. The negative direction of the Y axis indicates one direction from the upper side to the lower side The negative direction of the Z axis indicates one direction from the rear side to the front side.

FIG. 2 is a schematic diagram for explaining processing of the information processing device. FIG. 2 illustrates processing in which the information processing device detects the user's fingertip 72. First, the information processing device acquires an image 201 of the user captured from the sensor 500. Then, the information processing device determines a plurality of feature points 203 corresponding to the user's body and wrist from the acquired image 202.

Moreover, the information processing device acquires an image 204 including the plurality of feature points 203 corresponding to the wrist of the user. Then, the information processing device determines a plurality of feature points 205 corresponding to the user's hand from the acquired image 204, and detects the user's fingertip 72. When detecting the user's fingertip 72, the information processing device controls data displayed by the operation device 600 based on the position of the user's fingertip 72.

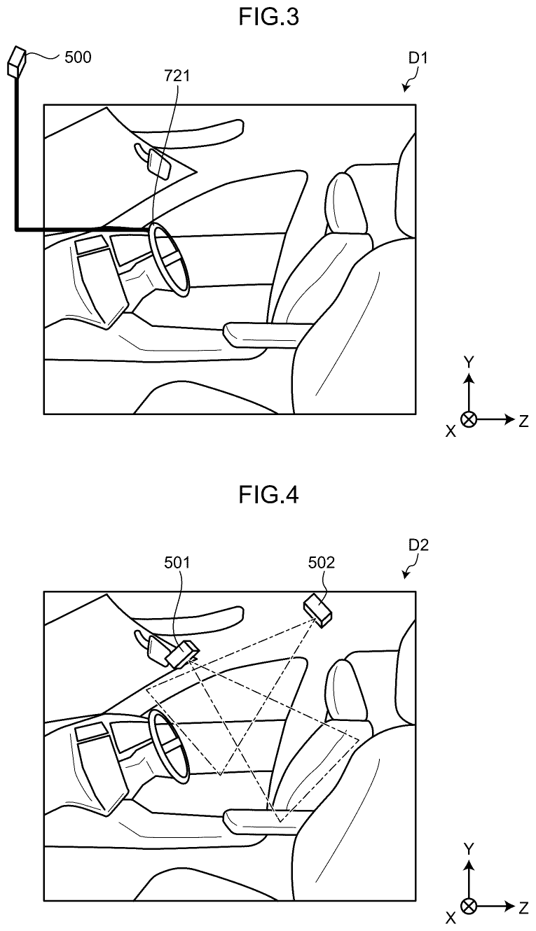

FIG. 3 is a schematic diagram for explaining arrangement of a sensor 500 according to a first comparative example. The schematic diagram illustrated in FIG. 3 illustrates an arrangement state D1 in a case where the sensor 500 is installed at a virtual position where the image 201 illustrated in FIG. 2 can be captured. Note that, in the present disclosure, a right-hand drive car as depicted in FIG. 3 is used as an example of a vehicle, whereas a left-hand drive car may be used instead. In FIG. 3, it is assumed that the hand of the user is on a steering wheel 721 in the vehicle.

For capturing the image 201 illustrated in FIG. 2, the sensor 500 may be placed outside the vehicle as in the arrangement state D1. If the sensor 500 is placed in the interior of the vehicle, the angle of view of the sensor 500 does not match, so that the image captured by the sensor 500 does not include the user's body and wrist.

For this reason, the information processing device cannot determine the user's wrist, and thereby there is a case where the user's fingertip 72 cannot be detected. Therefore, the present embodiment provides an information processing device that is capable of improving the accuracy of detecting the motion of the user's hand by placing the sensor 500 at a position where an image including the user's body and wrist in the vehicle interior can be captured.

FIG. 4 is a schematic diagram for explaining arrangement of a sensor 500 according to the first embodiment. The schematic diagram illustrated in FIG. 4 illustrates an arrangement state D2 that the sensor 500 is installed at a position in the vehicle interior where the image 201 illustrated in FIG. 2 can be captured.

As illustrated in the arrangement state D2, the sensor 500 includes a first sensor 501 and a second sensor 502. The first sensor 501 and the second sensor 502 are placed in front of the user and in forward direction of the user in the vehicle interior. The first sensor 501 is placed near a rearward viewing mirror in the vehicle interior to capture an image including the user's body.

The second sensor 502 is placed immediately above the seat on which the user sits in the vehicle interior to capture an image including the wrist of the user. With the above-described arrangement, the first sensor 501 and the second sensor 502 can capture an image including the user's body and hand in the vehicle interior.

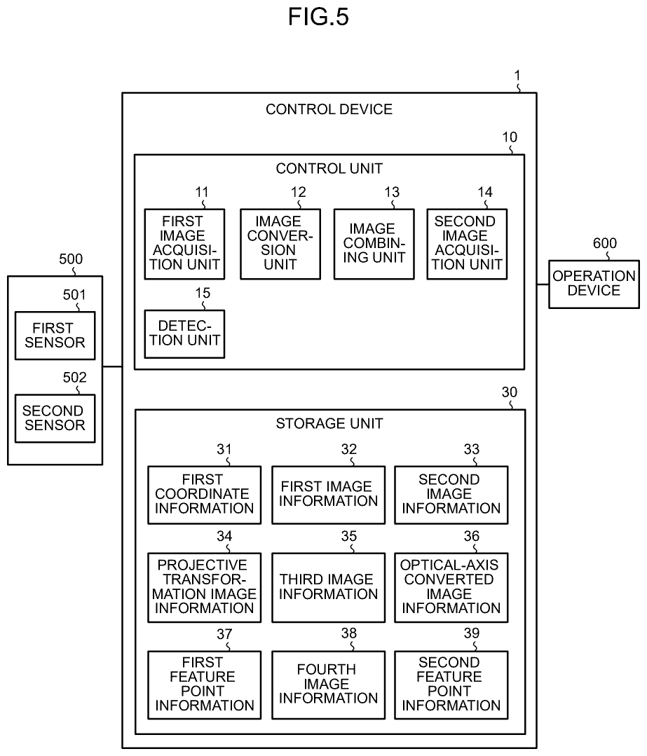

FIG. 5 is a diagram illustrating a schematic configuration of an information system including a control device that is the information processing device according to the first embodiment. The information processing device according to the first embodiment includes a sensor 500, an operation device 600, and a control device 1.

The sensor 500 is, for example, a camera device. The camera device is, for example, an infrared camera. Note that the camera device is not limited to the infrared camera, and may include a visible light camera. The sensor 500 is an example of an imaging unit. The sensor 500 captures an image of a user who is an operator and outputs the captured image to the control device 1.

The sensor 500 includes a first sensor 501 and a second sensor 502. The first sensor 501 is also referred to as a first camera. The second sensor 502 is also referred to as a second camera. The first sensor 501 captures an image including the user's body. The second sensor 502 captures an image including the user's wrist. The sensor 500 continuously performing image processing and outputs an image to the control device 1.

The sensor 500 is installed in the interior of the vehicle. The first sensor 501 and the second sensor 502 are placed apart from each other as illustrated in FIG. 4, and the optical axes of the first sensor 501 and the second sensor 502 cross each other. The first sensor 501 may be positioned on the front surface with respect to the user and in the positive direction of the Y axis and the negative direction of the Z axis on a YZ plane. Thus, the first sensor 501 is positioned obliquely upward with respect to the user.

The second sensor 502 may be positioned in the positive direction of the Y axis and the positive direction of the Z axis on the YZ plane with respect to the user. Thus, the second sensor 502 is positioned obliquely backward with respect to the user.

The operation device 600 is a display unit that displays various data. The operation device 600 is, for example, a display device such as a monitor display installed in a vehicle. The control device 1 executes processing of data displayed on the operation device 600 according to the motion of the user's fingertip 72 detected via the sensor 500.

The control device 1 includes a control unit 10 and a storage unit 30. The control unit 10 is configured as, for example, a central processing unit (CPU), and integrally controls operation of each unit of the control device 1. The control device 1 according to the present embodiment includes a ROM and a RAM (not illustrated). The ROM stores various programs. The RAM is a work area when the CPU executes a program.

The control device 1 includes, for example, a processor and a memory, and the processor executes a program stored in the memory, thereby implementing the functions of the functional blocks included in the control unit 10 and the control unit 10. The CPU is an example of a processor. The storage unit 30 is an example of the memory.

The CPU executes a program stored in the ROM by using the RAM as a work area, thereby implementing a first image acquisition unit 11, an image conversion unit 12, an image combining unit 13, a second image acquisition unit 14, and a detection unit 15 as illustrated in FIG. 5. This may be paraphrased as that the control device 1 includes the first image acquisition unit 11, the image conversion unit 12, the image combining unit 13, the second image acquisition unit 14, and the detection unit 15. The first image acquisition unit 11, the image conversion unit 12, the image combining unit 13, the second image acquisition unit 14, and the detection unit 15 may be implemented by different hardware.

The first image acquisition unit 11 acquires a first image including the user's body captured by the first sensor 501 and a second image including the user's wrist captured by the second sensor 502. The first image and the second image are images captured such that the optical axis of the first sensor 501 and the optical axis of the second sensor 502 intersect with each other.

The image conversion unit 12 converts the first image acquired by the first image acquisition unit 11 into a projective transformation image by performing projective transformation on the first image so as to match with the coordinate system of the second camera.

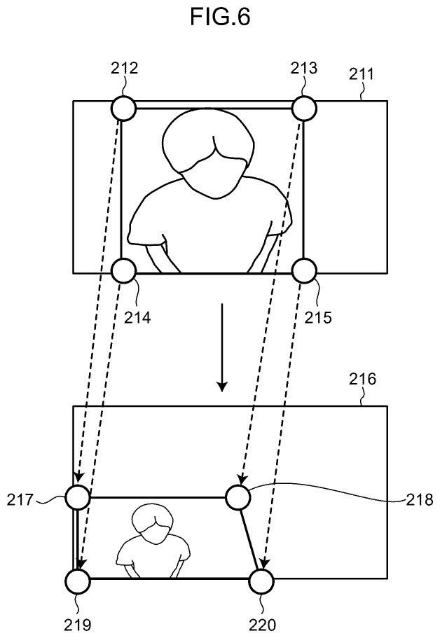

Here, the first image and the projective transformation image will be described with reference to FIG. 6. FIG. 6 is a schematic diagram for explaining processing of the control device 1 according to the first embodiment. In FIG. 6, processing performed by the image conversion unit 12 of the control unit 10 of the control device 1 will be described. FIG. 6 illustrates a first image 211 including the user's body acquired by the first image acquisition unit 11 and a projective transformation image 216 obtained by projective transformation of the first image 211 by the image conversion unit 12.

The first image 211 shows coordinates 212, coordinates 213, coordinates 214, and coordinates 215 of the first sensor 501. The image conversion unit 12 performs, for example, projective transformation of the first image 211 from the coordinates 212 to the coordinates 217 in order to perform projective transformation corresponding to the coordinate system in the second sensor 502. Similarly, the image conversion unit 12 performs projective transformation from the coordinates 213 to the coordinates 218, from the coordinates 214 to the coordinates 219, and from the coordinates 215 to the coordinates 220.

Returning to FIG. 5, the description will be continued. The image combining unit 13 generates the third image including the user's body and wrist by combining the first image and the second image acquired by the first image acquisition unit 11. In one example, the image combining unit 13 combines the projective transformation image 216, which is obtained by performing projective transformation on the first image 211 by the image conversion unit 12, and the optical-axis converted image, which is obtained by performing optical-axis conversion on the second image to align with the optical axis of the first sensor 501, and thereby obtains the third image including the user's body and wrist.

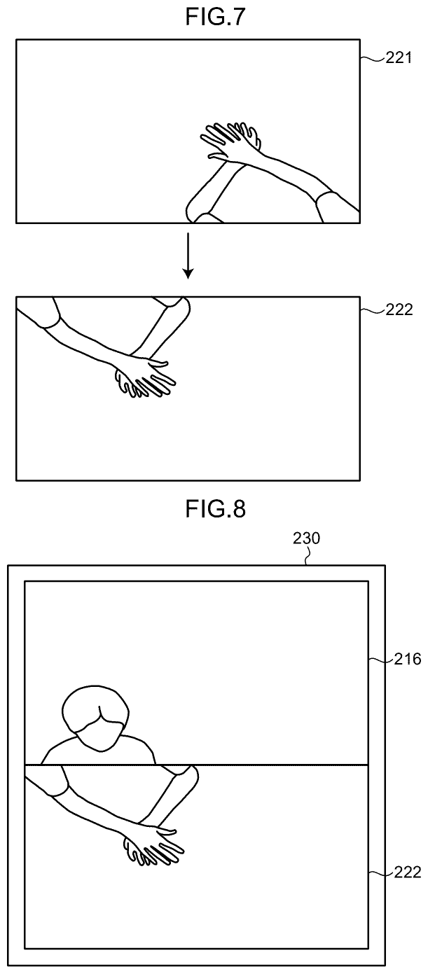

Here, the third image including the user's body and wrist will be described with reference to FIGS. 7 and 8. FIGS. 7 and 8 are schematic diagrams for explaining processing of the control device 1 according to the first embodiment. In FIGS. 7 and 8, processing performed by the image combining unit 13 of the control unit 10 of the control device 1 will be described.

FIG. 7 illustrates a second image 221 and an optical-axis converted image 222. The optical-axis converted image 222 is obtained by performing optical-axis conversion on the second image 221 so as to align with the optical axis of the first sensor 501. In one example, the image combining unit 13 rotates the second image 221 by 180 degrees to perform optical-axis conversion on the second image 221 to align with the optical axis of the first sensor 501. With this process, the image combining unit 13 converts the second image 221 into the optical-axis converted image 222.

FIG. 8 illustrates a third image 230 generated by the image combining unit 13. The third image 230 is generated by combining the projective transformation image 216 and the optical-axis converted image 222. The projective transformation image 216 is obtained by performing projective transformation on the first image 211 by the image conversion unit 12 illustrated in FIG. 6. The optical-axis converted image 222 is obtained by performing optical-axis conversion on the second image 221 so as to align with the optical axis of the first sensor 501. The third image 230 includes the user's body and wrist. In this way, the image combining unit 13 generates an image as the third image 230 including the user's body and wrist by combining the images acquired from the first sensor 501 and the second sensor 502 installed in the vehicle interior.

Returning to FIG. 5, the description will be continued. The second image acquisition unit 14 determines a plurality of first feature points corresponding to the body from the third image. The first feature points corresponding to the body include a plurality of third feature points corresponding to the wrist. The second image acquisition unit 14 acquires a fourth image including the hand based on the plurality of third feature points corresponding to the wrist. Specifically, the second image acquisition unit 14 determines the plurality of first feature points corresponding to the user's body from the third image including the user's body and wrist obtained by combining by the image combining unit 13. The second image acquisition unit 14 acquires the fourth image including the hand of the user based on the plurality of third feature points that corresponds to the wrist of the user and is included in the first feature points corresponding to the body.

The detection unit 15 determines the plurality of second feature points corresponding to the hand of the user from the fourth image including the hand of the user, which is acquired by the second image acquisition unit 14, and detects the motion of the hand of the user based on the plurality of second feature points. In the present embodiment, the hand of the user refers to a part from the wrist to the fingertip of the user.

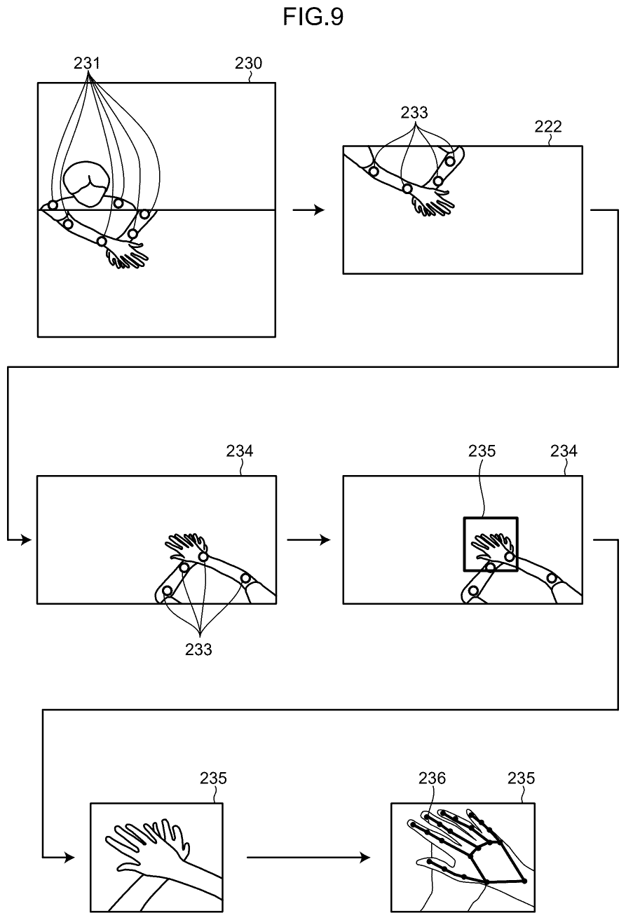

Here, the fourth image including the hand of the user will be described with reference to FIG. 9. FIG. 9 is a schematic diagram for explaining processing of the control device according to the first embodiment. In FIG. 9, processing performed by the second image acquisition unit 14 and the detection unit 15 of the control unit 10 of the control device 1 will be described.

The control device 1 determines a plurality of first feature points corresponding to the user's body from the third image including the user's body and wrist. The control device 1 acquires the fourth image including the user's hand based on the plurality of third feature points that corresponds to the wrist of the user and is included in the first feature points. The control device 1 determines the plurality of second feature points corresponding to the user's hand from the acquired fourth image including the user's hand. Then, the control device 1 detects the motion of the user's hand based on the plurality of second feature points.

More specifically, the second image acquisition unit 14 determines a plurality of first feature points 231 corresponding to the user's body from the third image 230 that includes the user's body and wrist and is generated by combining by the image combining unit 13. The second image acquisition unit 14 determines a plurality of third feature points 233 corresponding to the user's wrist. The plurality of third feature points 233 are included in the first feature points 231. The second image acquisition unit 14 determines the respective positions corresponding to the first feature points 231 in the optical-axis converted image 222, and applies the first feature points 231 to the optical-axis converted image 222 based on the determined positions. Further, the second image acquisition unit 14 performs optical-axis conversion so as to align the optical-axis converted image 222 with the optical axis of the second sensor 502. That is, the second image acquisition unit 14 converts the optical-axis converted image 222 into a second image 234.

Then, the second image acquisition unit 14 acquires a fourth image 235 including the user's hand from the second image 234 based on the plurality of third feature points 233 corresponding to the user's wrist. In addition, the detection unit 15 determines a plurality of second feature points 236 corresponding to the user's hand from the fourth image 235 including the user's hand, and detects the motion of the user's hand based on the plurality of second feature points 236. Therefore, the control device 1 can detect the motion of the user's hand, so that the accuracy of detecting the motion of the user's hand can be improved.

Returning to FIG. 5, the description will be continued. The storage unit 30 stores various types of information. The storage unit 30 is implemented by hardware for storing information (in other words, data), such as a memory or a storage. Specifically, the storage unit 30 stores first coordinate information 31, first image information 32, second image information 33, projective transformation image information 34, third image information 35, optical-axis converted image information 36, first feature point information 37, fourth image information 38, and second feature point information 39.

The first coordinate information 31 is three-dimensional coordinates of an installation position of the sensor 500 having the first sensor 501 and the second sensor 502, information of an attachment angle of the sensor 500, three-dimensional coordinates of a position of the operation device 600, and the like. The first image information 32 is information including an image including the user's body captured by the first sensor 501 and a date and time when the first sensor 501 captured the image. The second image information 33 is information including an image including the user's wrist captured by the second sensor 502 and a date and time when the second sensor 502 captures the image.

The projective transformation image information 34 is information including a projective transformation image obtained by performing projective transformation on the first image by the control device 1 so as to match with the coordinate system of the second camera. The third image information 35 includes the third image generated by the control device 1. The third image includes the user's body and wrist and is obtained by combining of the first image and the second image. The optical-axis converted image information 36 includes an optical-axis conversion image that is obtained by the control device 1 by performing optical-axis conversion to align the second image with the optical axis of the first sensor 501.

The first feature point information 37 includes the plurality of first feature points that corresponds to the user's body and is determined from the third image by the control device 1. The first feature points include the plurality of third feature points corresponding to the user's wrist. The fourth image information 38 includes the fourth image that includes the hand of the user and is acquired by the control device 1. The second feature point information 39 includes the plurality of second feature points 236 that corresponds to the user's hand and is detected from the fourth image by the control device 1.

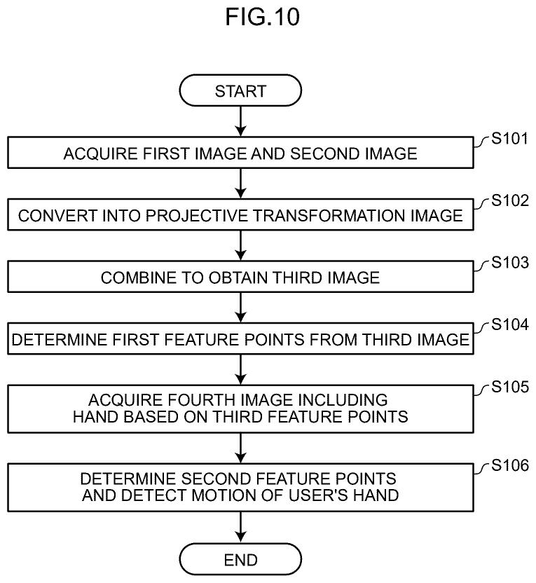

Next, a processing procedure of the control device 1 according to the first embodiment will be described with reference to FIG. 10. FIG. 10 is a flowchart illustrating a processing procedure of the control device 1 according to the first embodiment. Note that, in the present processing, a processing procedure of detecting the user's hand will be described.

First, the first image acquisition unit 11 acquires the first image including the user's body captured by the first sensor 501 and the second image including the user's wrist captured by the second sensor 502 (Step S101). Subsequently, the image conversion unit 12 converts the first image acquired by the first image acquisition unit 11 into a projective transformation image by performing projective transformation on the first image so as to match with the coordinate system of the second camera (Step S102).

Subsequently, the image combining unit 13 combines the first image and the second image acquired by the first image acquisition unit 11 to generate the third image including the user's body and wrist (Step S103). For example, the image combining unit 13 obtains the third image including the user's body and wrist by combining the projective transformation image and the optical-axis converted image. The projective transformation image is obtained by performing projective transformation on the first image by the image conversion unit 12. The optical-axis converted image is obtained by performing optical-axis conversion on the second image so as to align with the optical axis of the first sensor 501.

Subsequently, the second image acquisition unit 14 determines the plurality of first feature points corresponding to the user's body from the third image including the user's body and wrist (Step S104). Then, the second image acquisition unit 14 acquires the fourth image including the hand of the user based on the plurality of third feature points that corresponds to the user's wrist and is included in the first feature points (Step S105). Subsequently, the detection unit 15 determines the plurality of second feature points corresponding to the user's hand from the fourth image including the user's hand, and detects the motion of the user's hand based on the second feature points (Step S106). When the processing in step S106 ends, the control device 1 performs processing of controlling the operation device 600 based on, for example, the motion of the user's hand.

As described above, the control device 1 according to one aspect of the present disclosure acquires a first image including the user's body captured by a first camera and a second image including the user's wrist captured by a second camera. The control device 1 generates a third image including the body and the wrist of the user by combining the first image and the second image. The control device 1 determines a plurality of first feature points corresponding to the user's body from the third image, and acquires a fourth image including the hand of the user based on the plurality of third feature points corresponding to the user's wrist. The control device 1 determines a plurality of second feature points corresponding to the user's hand from the fourth image, and detects the motion of the user's hand based on the plurality of second feature points.

Moreover, the control device 1 converts the first image into a projective transformation image by performing projective transformation on the first image to match with the coordinate system of the second camera. Then, the control device 1 combines the projective transformation image and the optical-axis converted image to obtain the third image. The optical-axis converted image is obtained by performing optical-axis conversion so as to align the second image with the optical axis of the first camera.

There may be a case where the camera installed in the vehicle interior cannot capture both the user's body and hand within the angle of view of the camera, and the acquired image does not include the user's body and hand. Even in such a case, the control device 1 determines the plurality of first feature points corresponding to the user's body from a composite image obtained by combining the image including the user's body and the image including the user's wrist, acquires the image including the user's hand from the third feature points corresponding to the wrist included in the determined first feature points, and determines the plurality of second feature points corresponding to the user's hand from the image including the user's hand. Therefore, the control device 1 can detect the motion of the hand of the user from the determined second feature points. Therefore, the control device 1 can improve the accuracy of detecting the motion of the user's hand.

Note that the above-described embodiment can be appropriately modified and implemented by changing part of the configuration or function of the devices described above. Therefore, in the following, some modifications according to the above-described embodiment will be described as other embodiments. In the following description, points different from the above-described embodiment will be mainly described, and detailed description of points common to the contents already described will be omitted.

### Second Embodiment

In the first embodiment described above, the control device 1 determines the plurality of first feature points corresponding to the user's body from the third image including the user's body and wrist, and acquires the fourth image including the user's hand based on the third feature points corresponding to the user's wrist. Meanwhile, there may be a case where the first feature points of the user's body cannot be determined from the third image that includes the user's body and wrist and is generated by the image combining unit 13. This event may occur, for example, when a monocular camera having a narrow angle of view is used as the first sensor 501 in the vehicle interior.

Therefore, in the second embodiment, when the control device 1 cannot determine the plurality of first feature points corresponding to the user's body from the third image including the user's body and wrist, the user's wrist is determined from the second image including the user's wrist, and then the fourth image including the user's hand is acquired.

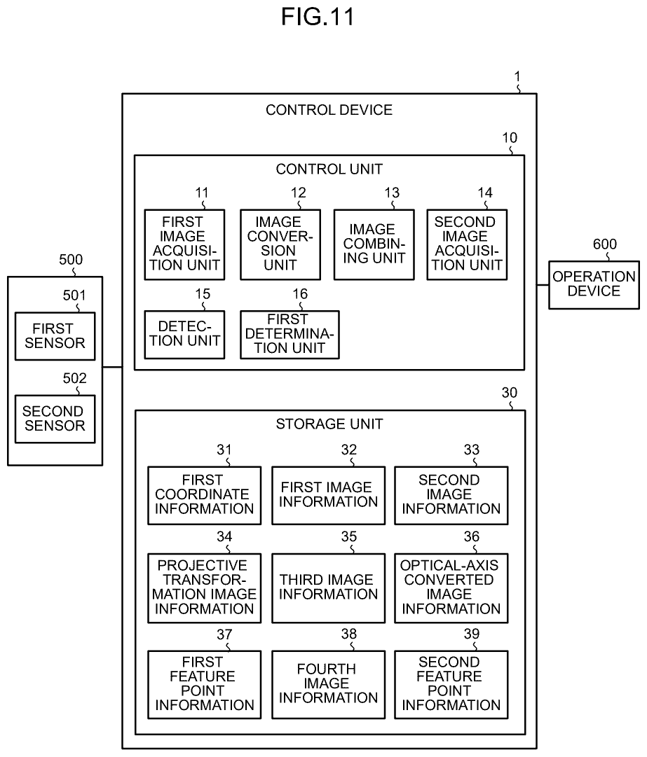

FIG. 11 is a diagram illustrating a schematic configuration of an information system including the control device 1 that is an information processing device according to the second embodiment. The information processing device according to the second embodiment further implements a first determination unit 16 of a control unit 10 of a control device 1 as compared with the information processing device according to the first embodiment. The first determination unit 16 may be implemented by the CPU that executes a computer program stored in the ROM by using the RAM as a work area. This may be paraphrased as that the control device 1 includes the first determination unit 16. The first determination unit 16 may be implemented by hardware different from that for the first image acquisition unit 11, the image conversion unit 12, the image combining unit 13, the second image acquisition unit 14, and the detection unit 15.

The first determination unit 16 determines whether the plurality of first feature points corresponding to the user's body can be determined from the third image that includes the user's body and wrist and is generated by the image combining unit 13.

When the first determination unit 16 determines that the plurality of first feature points corresponding to the body can be determined from the third image, the second image acquisition unit 14 determines the plurality of first feature points corresponding to the body from the third image, and acquires the fourth image including the user's hand based on the plurality of third feature points corresponding to the user's wrist. In one example, the second image acquisition unit 14 determines the third feature points corresponding to the user's wrist included in the first feature points, and acquires the fourth image including the user's hand. Then, the detection unit 15 determines the plurality of second feature points corresponding to the user's hand from the fourth image including the user's hand, and detects the motion of the user's hand based on the plurality of second feature points.

On the other hand, when the first determination unit 16 determines that the plurality of first feature points corresponding to the body cannot be determined from the third image, the second image acquisition unit 14 fixes the target region of the second image including the user's wrist acquired by the first image acquisition unit 11 and acquires the fourth image including the user's hand. Then, the first determination unit 16 determines whether the plurality of third feature points corresponding to the wrist can be determined from the fourth image including the user's hand acquired by the second image acquisition unit 14.

When the first determination unit 16 determines that the plurality of third feature points corresponding to the user's wrist can be determined from the fourth image including the hand, the detection unit 15 determines the plurality of second feature points corresponding to the user's hand from the fourth image, and detects the motion of the user's hand based on the plurality of second feature points.

When the first determination unit 16 determines that the plurality of third feature points corresponding to the wrist cannot be determined from the fourth image including the hand, the second image acquisition unit 14 slides the target region of the second image including the user's wrist acquired by the first image acquisition unit 11. Then, the second image acquisition unit 14 fixes the target region of the second image and acquires the fourth image.

Thereafter, until the plurality of third feature points corresponding to the user's wrist can be determined by the first determination unit 16 from the fourth image including the user's hand, the second image acquisition unit 14 slides the target region of the second image including the user's wrist and fixes the target region of the slid second image to acquire the fourth image.

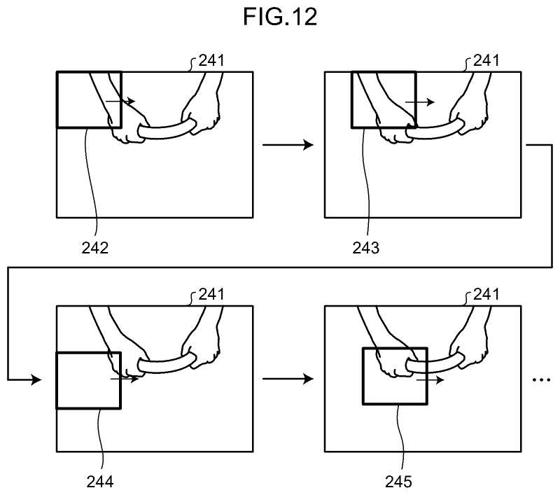

Here, processing in which the second image acquisition unit 14 determines the wrist from the second image including the user's wrist will be described with reference to FIG. 12. FIG. 12 is a schematic diagram for explaining processing of the control device 1 according to the second embodiment. In FIG. 12, a second image 241 is illustrated. The second image acquisition unit 14 performs processing along an arrow illustrated in FIG. 12 and determines the wrist from the second image. FIG. 12 also illustrates a target region 242, a target region 243, a target region 244, and a target region 245, each corresponding to the user's wrist.

As illustrated in FIG. 12, the second image acquisition unit 14 slides the target region 243 from the target region 242 located at the upper left end of the second image 241 toward the right end. When the sliding is completed to the upper right end, the second image acquisition unit 13 moves to the target region 244 located at the left end, and slides the target region 245 toward the right end again. Then, the second image acquisition unit 13 sequentially continues this processing, and when the sliding is completed to the lower right end, the second image acquisition unit 14 returns to the upper left end again. With this processing, the second image acquisition unit 14 can determine the wrist from the second image including the user's wrist and acquire the fourth image including the user's hand.

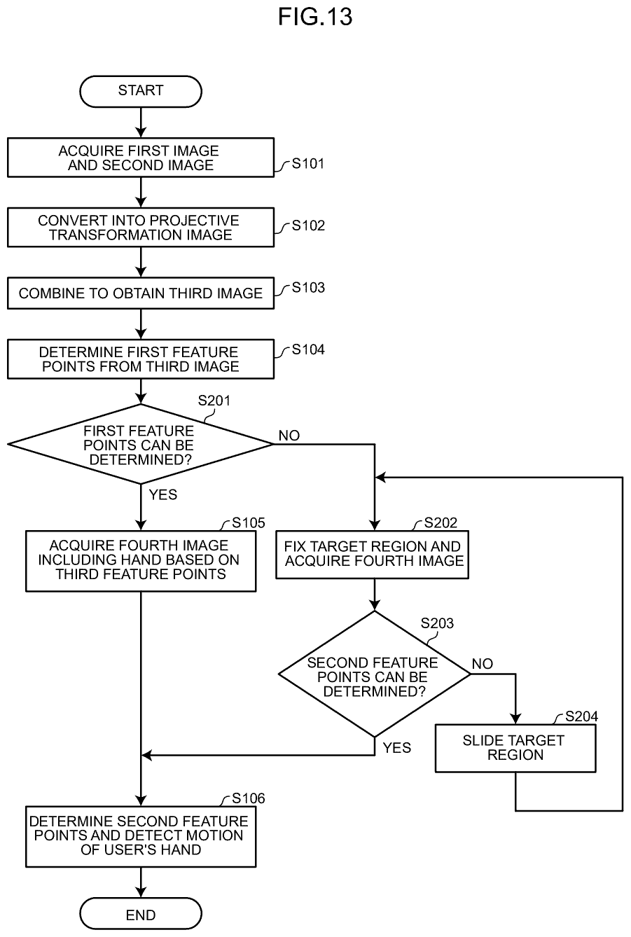

Next, a processing procedure of the control device 1 according to the second embodiment will be described with reference to FIG. 13. FIG. 13 is a flowchart illustrating a processing procedure of the control device 1 according to the second embodiment. Note that the processing from Step S101 to Step S106 in the flowchart illustrated in FIG. 13 is similar to the processing from Step S101 to Step S106 in the flowchart illustrated in FIG. 10, and thus description thereof is omitted.

In Step S201, the first determination unit 16 determines whether the plurality of first feature points corresponding to the body can be determined from the third image that includes the user's body and wrist and is generated by the image combining unit 13 (Step S201). When the first determination unit 16 determines that the plurality of first feature points corresponding to the body can be determined from the third image (Step S201: Yes), the process proceeds to Step S105.

On the other hand, when the first determination unit 16 determines that the plurality of first feature points corresponding to the body cannot be determined from the third image (Step S201: No), the process proceeds to Step S202. In Step S202, the second image acquisition unit 14 fixes the target region of the second image including the user's wrist acquired by the first image acquisition unit 11, and acquires the fourth image including the user's hand (Step S202). Subsequently, the first determination unit 16 determines whether the plurality of second feature points corresponding to the hand can be determined from the fourth image including the hand (Step S203).

When the first determination unit 16 determines that the plurality of second feature points can be determined from the fourth image (Step S203: Yes), the process proceeds to Step S106. On the other hand, when the first determination unit 16 determines that the plurality of second feature points cannot be determined from the fourth image (Step S203: No), the process proceeds to Step S204. In Step S204, the second image acquisition unit 14 slides the target region of the second image including the user's wrist acquired by the first image acquisition unit 11 (Step S204). When Step S204 ends, the processing of the control device 1 proceeds to Step S202 and continues the subsequent processing.

As described above, when the plurality of third feature points corresponding to the user's body cannot be determined from the third image, the control device 1 according to one aspect of the present disclosure determines the wrist from the second image including the user's wrist and acquires the fourth image. Therefore, even in a case where the feature points of the user's body cannot be determined from the third image including the user's body and wrist, the control device 1 can determine the user's wrist from the second image including the user's wrist and acquire the fourth image including the user's hand. Therefore, the control device 1 can improve the accuracy of detecting the motion of the user's hand.

### First Modification

In the second embodiment described above, when the control device 1 determines the wrist from the second image including the user's wrist, the processing of sliding from the upper left end to the lower right end of the second image is performed, but the processing is not limited thereto. The processing to determine the user's wrist from the second image including the user's wrist may be processing to slid from the lower left end to the upper right end of the second image.

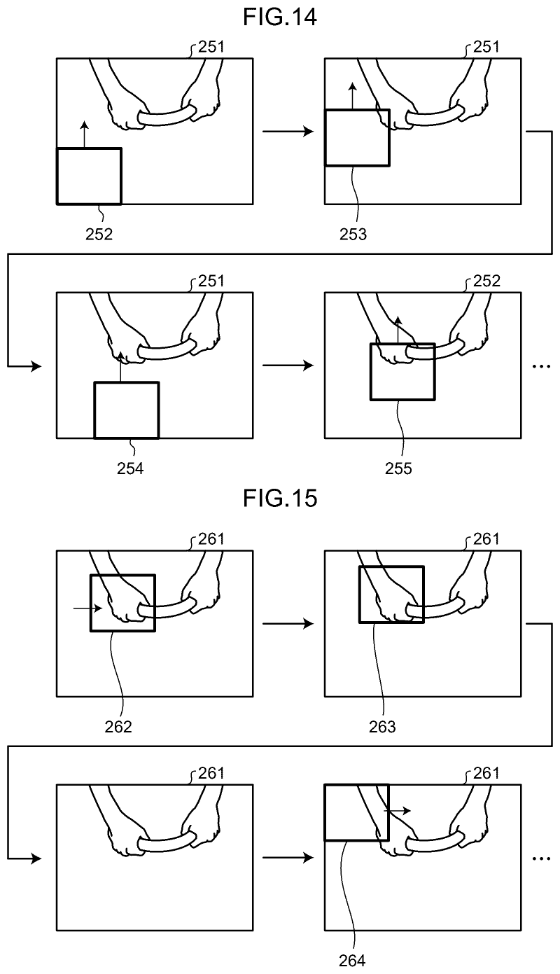

FIG. 14 is a schematic diagram for explaining processing of the control device 1 according to a first modification. FIG. 14 illustrates a second image 251. The second image acquisition unit 14 performs processing along an arrow illustrated in FIG. 14 and determines the wrist from the second image. In addition, FIG. 14 illustrates a target region 252, a target region 253, a target region 254, and a target region 255 corresponding to the wrist.

As illustrated in FIG. 14, the second image acquisition unit 14 slides the target region 253 upward from the target region 252 located at the lower left end of the second image 251. When the sliding is completed to the upper left end, the second image acquisition unit 13 moves to the target region 254 located at the lower end, and slides the target region 255 upward again. Then, the second image acquisition unit 14 sequentially continues this processing, and when the sliding is completed to the upper right end, the second image acquisition unit 13 returns to the lower left end again. Therefore, the control device 1 can determine the wrist from the second image including the user's wrist and acquire the fourth image including the hand of the user. Therefore, the control device 1 can improve the accuracy of detecting the motion of the user's hand.

### Second Modification

In the second embodiment and the first modification described above, the control device 1 determines the user's wrist from the second image including the user's wrist. In a second modification, processing in a case where the control device 1 determines the wrist from the second image including the user's wrist, acquires the fourth image including the hand, and loses sight of the detected hand while detecting the motion of the hand will be described.

FIG. 15 is a schematic diagram for explaining processing of the control device 1 according to the second modification. FIG. 15 illustrates a second image 261. The second image acquisition unit 14 performs processing along an arrow illustrated in FIG. 15 and determines the wrist from the second image. In addition, FIG. 15 illustrates a target region 262 and a target region 264 corresponding to the wrist. Here, the second image acquisition unit 14 determines the wrist in the target region 262 and acquires a fourth image 263.

When the detection unit 15 loses sight of the user's hand in a state where the motion of the user's hand is being detected from the fourth image 263, the second image acquisition unit 14 is required to acquire again the fourth image including the user's hand. Therefore, as illustrated in FIG. 15, the second image acquisition unit 14 slides from the target region 264 located at the upper left end of the second image 261 toward the upper right end, and continues the processing until the fourth image including the user's hand can be acquired. Therefore, even in a case where the motion of the hand is lost, the control device 1 can detect the motion of the hand by acquiring the fourth image including the hand again. Therefore, the control device 1 can improve the accuracy of detecting the motion of the user's hand.

### Third Modification

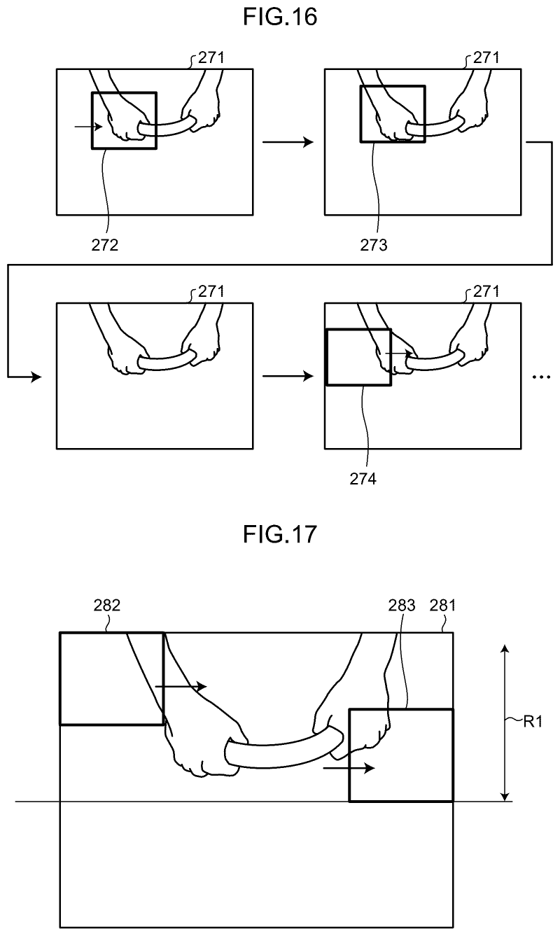

FIG. 16 is a schematic diagram for explaining processing of the control device 1 according to a third modification. FIG. 16 illustrates a second image 271. The second image acquisition unit 14 performs processing along an arrow illustrated in FIG. 16 and determines the wrist from the second image. In addition, FIG. 16 illustrates a target region 272 and a target region 274 corresponding to the wrist. Here, the second image acquisition unit 14 determines the wrist in the target region 272 and acquires a fourth image 273.

When the detection unit 15 has lost the user's hand in a state where the motion of the user's hand is being detected from the fourth image 273, the second image acquisition unit 14 slides leftward with respect to the target region 272 as illustrated in FIG. 16, namely, slides so as to be in the state of the target region 274 which is the state immediately before the target region 272, and continues the processing until the fourth image including the hand of the user can be acquired. Therefore, even in a case where the motion of the hand is lost, the control device 1 can detect the motion of the hand by acquiring the fourth image including the hand again. Therefore, the control device 1 can improve the accuracy of detecting the motion of the user's hand.

### Third Embodiment

In the above-described embodiment, when the control device 1 determines the wrist from the second image including the user's wrist, the wrist is determined from all the regions of the second image. However, the processing is not limited thereto. For example, the control device 1 may determine the third feature points corresponding to the wrist from the region set in advance in the second image and acquire the fourth image.

FIG. 17 is a schematic diagram for explaining processing of a control device 1 according to a third embodiment. FIG. 17 illustrates a second image 281. As illustrated in the second image 281, the user's wrist exists only in a partial region in the second image 281. Therefore, the second image acquisition unit 14 determines the third feature points corresponding to the wrist from the region set in advance in the second image 281 and acquires the fourth image.

As illustrated in FIG. 17, in the region R1 of the upper half of the second image 281, the second image acquisition unit 14 slides from the target region 282 located at the upper left end of the second image 281 toward the upper right end, further slides to the target region 283, and continues the processing until the fourth image including the hand of the user can be acquired. In addition, the region set in advance is not limited to the upper half region of the second image 281, and may be set according to the movable range of the hand of the user. Therefore, the control device 1 can shorten the processing time until the fourth image including the hand of the user is acquired.

### Fourth Embodiment

There may be a case where the control device 1 cannot determine a plurality of second feature points corresponding to the user's hand due to the fourth image including the user's hand being obscure. In a fourth embodiment, processing in a case where the fourth image including the user's hand is obscure will be described.

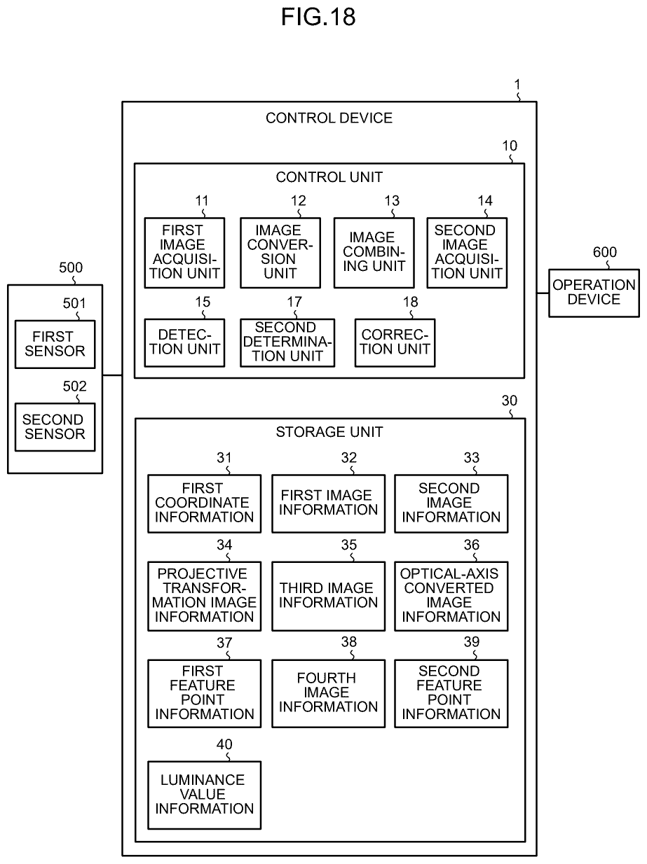

FIG. 18 is a diagram illustrating a schematic configuration of an information system including a control device 1 that is an information processing device according to a fourth embodiment. The information processing device according to the fourth embodiment further implements a second determination unit 17 and a correction unit 18 of a control unit 10 of the control device 1 and luminance value information 40 of a storage unit 30 of the control device 1 as compared with the information processing device according to the first embodiment. The correction unit 18 may be implemented by the CPU that executes a computer program stored in the ROM by using the RAM as a work area. This may be paraphrased as that the control device 1 includes the correction unit 18. The correction unit 18 may be implemented by hardware different from that for the first image acquisition unit 11, the image conversion unit 12, the image combining unit 13, the second image acquisition unit 14, and the detection unit 15.

The second determination unit 17 determines whether the luminance value of the fourth image including the hand of the user acquired by the second image acquisition unit 14 satisfies a predetermined condition. In a case where the second determination unit 17 determines that the luminance value of the fourth image satisfies the predetermined condition, the detection unit 15 determines the plurality of second feature points corresponding to the hand of the user from the fourth image, and detects the motion of the hand of the user based on the plurality of second feature points.

In a case where the second determination unit 17 determines that the luminance value of the fourth image including the hand of the user does not satisfy the predetermined condition, the correction unit 18 corrects the luminance value of the fourth image.

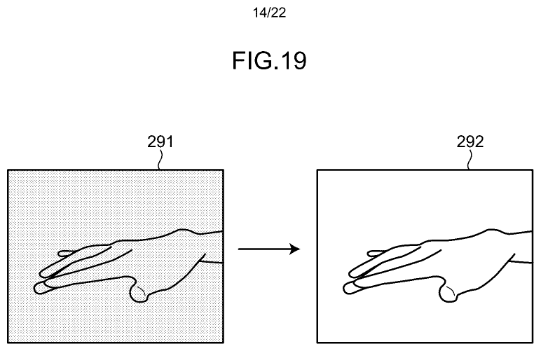

Here, correction processing executed by the correction unit 18 will be described. FIG. 19 is a schematic diagram for explaining processing of the control device 1 according to the fourth embodiment. FIG. 19 illustrates a fourth image 291 before correction and a fourth image 292 after correction.

In a case where the luminance value of fourth image 291 does not satisfy the predetermined condition, the correction unit 18 generates the fourth image 292 by correcting the luminance value of the fourth image. The correction unit 18 adds up the luminance of each pixel of the fourth image 291. When the sum of the added luminance values is greater than or equal to the predetermined luminance value, the correction unit 18 corrects the luminance value to be decreased. When the sum of the added luminance values is equal to or less than predetermined luminance, the correction unit 18 corrects the luminance value to be increased. Therefore, the control device 1 can make the fourth image including the user's hand clearer. For the processing of correcting the luminance value, a known method, such as dynamic range extension processing, may be used.

Returning to FIG. 18, the description will be continued. The luminance value information 40 is information including the above-described predetermined luminance value. The predetermined condition of the luminance value is set according to the specification of the sensor 500.

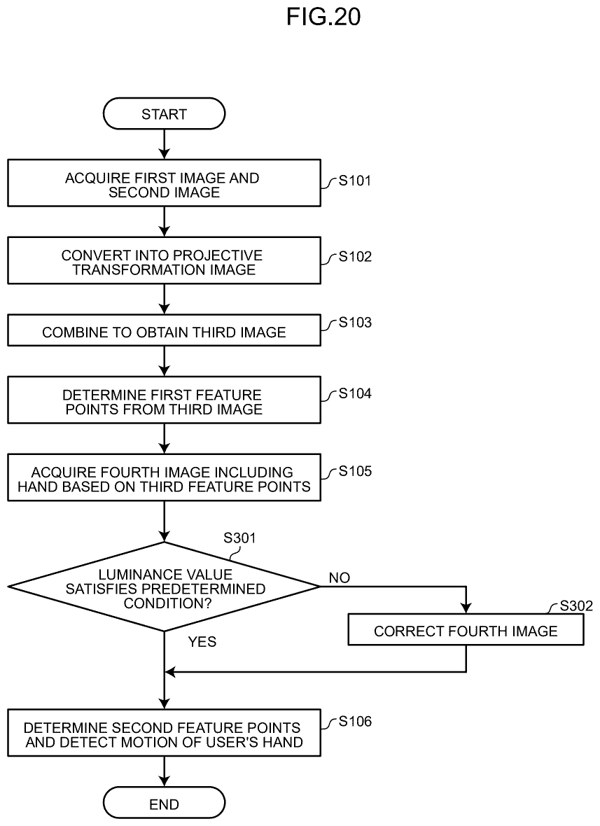

Next, a processing procedure of the control device 1 according to the fourth embodiment will be described with reference to FIG. 20. FIG. 20 is a flowchart illustrating a processing procedure of the control device 1 according to the fourth embodiment. Note that the processing from Step S101 to Step S106 in the flowchart illustrated in FIG. 20 is similar to the processing from Step S101 to Step S106 in the flowchart illustrated in FIG. 10, and thus description thereof is omitted.

In Step S301, the second determination unit 17 determines whether the luminance value of the fourth image including the hand of the user acquired by the second image acquisition unit 14 satisfies a predetermined condition (Step S301). When the second determination unit 17 determines that the luminance value of the fourth image satisfies the predetermined condition (Step S301: Yes), the process proceeds to Step S106.

On the other hand, when the second determination unit 17 determines that the luminance value of the fourth image does not satisfy the predetermined condition (Step S301: No), the process proceeds to Step S302. In Step S302, the correction unit 18 corrects the luminance value of the fourth image (Step S302). When Step S302 ends, the processing of the control device 1 proceeds to Step S106.

As described above, in a case where the luminance value of fourth image does not satisfy the predetermined condition, the control device 1 according to one aspect of the present disclosure corrects the luminance value of the fourth image. As a result, the fourth image including the hand of the user becomes clear. Therefore, the control device 1 can detect the motion of the user's hand, so that the accuracy of detecting the motion of the user's hand can be improved.

### Fourth Modification

As a fourth modification, an information processing device including one sensor 500 will be described. In the above-described embodiments, images captured by two cameras are combined. In contrast, in the fourth modification, a still image including the user's body and a camera image showing the user's wrist and hand are combined. With this configuration, even one camera can detect the motion of the user's hand. In addition, in the second and third embodiments and the first, second, and third modifications described above, the third image including the user's body and wrist is generated by combining images captured by the first sensor 501 and the second sensor 502. When a plurality of first feature points corresponding to the user's body cannot be determined from the third image, a target region is slid on the second image including the user's wrist to determine a new target region. Then, the fourth image including the user's hand is acquired, the second feature points corresponding to the user's hand are determined, and the motion of the user's hand is detected.

In contrast, in the fourth modification, the number of the sensor 500 is one. Therefore, depending on the position of the sensor 500 in the vehicle interior, there may be some cases where the body cannot be imaged even if the user's wrist and hand can be imaged. In such a case, an information processing device according to the fourth modification is configured to determine a user's wrist from an image including at least the user's wrist imaged by a single camera, and acquires an image including the user's hand based on the determined wrist. Then, the motion of the user's hand is detected from the image including the user's hand. The fourth embodiment described above can be applied to the information processing device of the fourth modification.

The information processing device according to the fourth modification may be an information processing device that operates based on the motion of the hand of the user. The information processing device may include: a first image acquisition unit 11 that acquires an image including at least the wrist of the user imaged by a camera; a second image acquisition unit 14 that determines a plurality of third feature points corresponding to the wrist from the image including the wrist and acquires an image including the hand of the user based on the plurality of third feature points; and a detection unit 15 that determines a plurality of second feature points corresponding to the hand of the user from the image including the hand and detects the motion of the hand based on the plurality of second feature points.

Therefore, the control device 1 can determine the wrist from the image including the user's wrist and acquire the image including the hand of the user. Therefore, the control device 1 can improve the accuracy of detecting the motion of the user's hand even if there is one sensor 500.

### Fifth Embodiment

The sensor 500 may be installed in the vehicle interior other than the arrangement state D2 illustrated in FIG. 3 described above. Such an arrangement of the sensor 500 in the vehicle interior will be described.

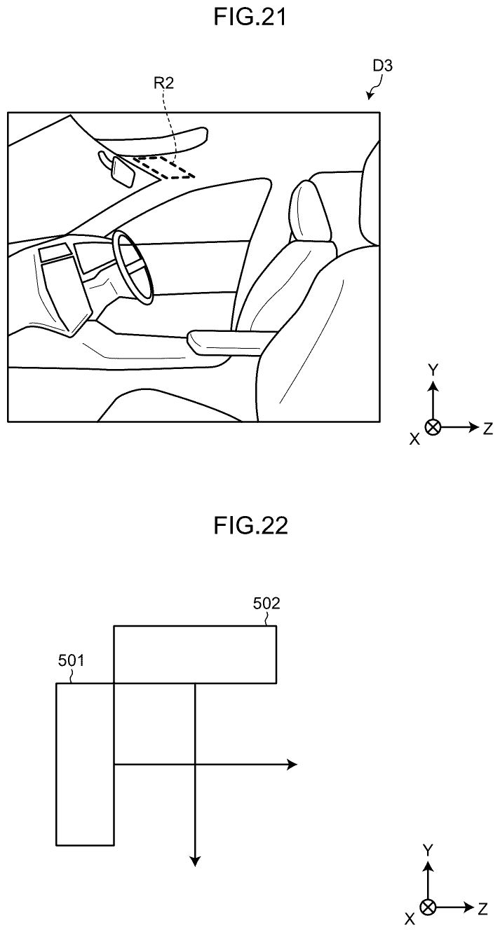

FIG. 21 is a schematic diagram for explaining arrangement of the sensor 500 according to the fifth embodiment. The schematic diagram illustrated in FIG. 21 illustrates an arrangement state D3 in a case where the sensor 500 is installed in the vehicle at a position where the image 201 illustrated in FIG. 2 can be captured. The sensor 500 according to the fifth embodiment is placed in a region R2 in the arrangement state D3. The region R2 is a region located in front of and in forward direction of the user in the vehicle interior.

FIG. 22 is a schematic diagram for explaining arrangement of the sensor 500 according to the fifth embodiment. The schematic diagram illustrated in FIG. 22 illustrates a state in which the first sensor 501 and the second sensor 502 are arranged in the region R2 in the arrangement state D3 illustrated in FIG. 21.

The first sensor 501 is placed in the positive direction of the Z axis on the YZ plane so as to capture an image including the user's face and body. The second sensor 502 is placed in the negative direction of the Y axis on the YZ plane so as to capture an image including the user's arm, wrist, and hand.

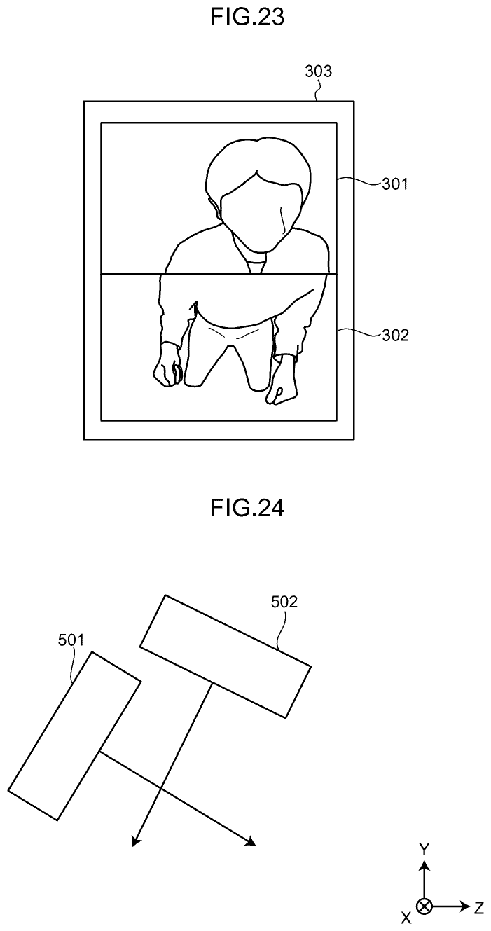

FIG. 23 is a schematic diagram for explaining the contents of processing of the control device 1 according to the fifth embodiment. With reference to FIG. 23, processing performed by the image combining unit 13 of the control unit 10 of the control device 1 will be described. FIG. 23 illustrates a third image 303 generated by the image combining unit 13. The third image 303 in FIG. 23 is obtained by combining an image 301 captured by the first sensor 501 in FIG. 22 and an image 302 captured by the second sensor 502 in FIG. 22.

In addition, the image 301 and the image 302 are images captured such that the optical axis of the first sensor 501 and the optical axis of the second sensor 502 intersect with each other. Therefore, the image combining unit 13 can combine the images acquired from the first sensor 501 and the second sensor 502 installed in the vehicle interior and thereby obtain an image including the user's body and wrist.

### Fifth Modification

In a fifth modification, an arrangement of the sensor 500 in the vehicle interior different from that of the fifth embodiment will be described. FIG. 24 is a schematic diagram for explaining arrangement of a sensor 500 according to the fifth modification. The schematic diagram illustrated in FIG. 24 illustrates a state in which the first sensor 501 and the second sensor 502 are arranged in the region R2 in the arrangement state D3 illustrated in FIG. 21. The first sensor 501 is placed in the negative direction of the Y axis and in the positive direction of the Z axis on the YZ plane so as to capture an image including the user's face.

The second sensor 502 is placed in the negative direction of the Y axis and in the negative direction of the Z axis on the YZ plane so as to capture an image including the user's body, arm, wrist, and hand.

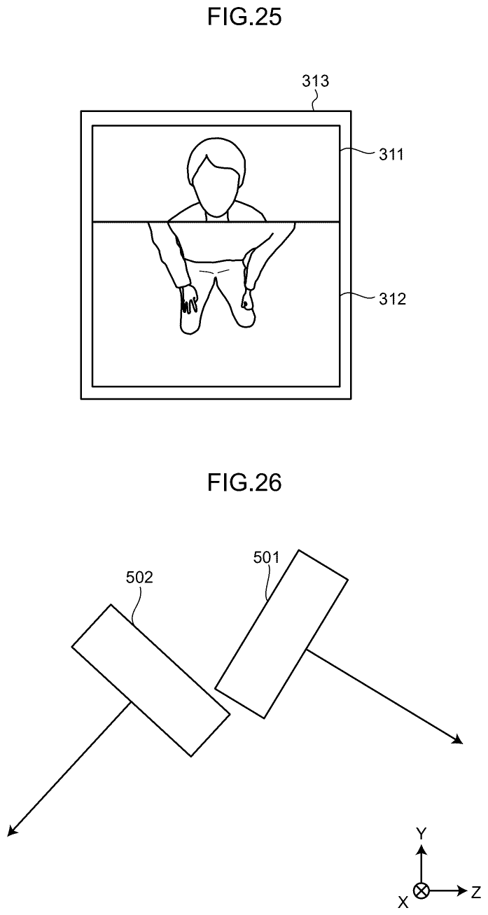

FIG. 25 is a schematic diagram for explaining the contents of processing of the control device 1 according to the fifth modification. With reference to FIG. 25, processing performed by the image combining unit 13 of the control unit 10 of the control device 1 will be described.

FIG. 25 illustrates a third image 313 generated by the image combining unit 13. The third image 313 in FIG. 25 is an image obtained by combining an image 311 captured by the first sensor 501 in FIG. 24 and an image 312 captured by the second sensor 502 in FIG. 24. The image 311 and the image 312 are images captured such that the optical axis of the first sensor 501 and the optical axis of the second sensor 502 intersect with each other. Therefore, the image combining unit 13 can combine the images acquired from the first sensor 501 and the second sensor 502 installed in the vehicle interior and thereby obtain an image including the user's body and wrist.

### Sixth Modification

In a sixth modification, the arrangement of a sensor 500 in the vehicle interior different from that of the fifth embodiment and the fifth modification will be described. FIG. 26 is a schematic diagram for explaining arrangement of the sensor 500 according to the sixth modification. The schematic diagram illustrated in FIG. 26 illustrates a state in which the first sensor 501 and the second sensor 502 are arranged in the region R2 in the arrangement state D3 illustrated in FIG. 21. The first sensor 501 is placed in the negative direction of the Y axis and in the positive direction of the Z axis on the YZ plane so as to capture an image including the user's face, body, and arm.

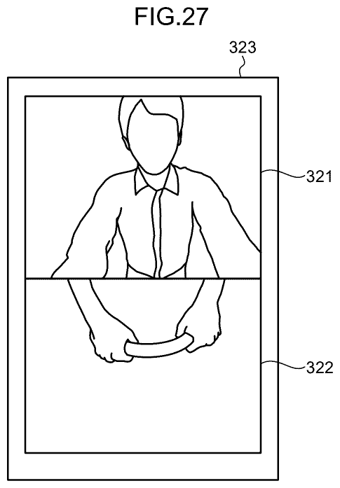

The second sensor 502 is placed in the negative direction of the Y axis and in the negative direction of the Z axis on the YZ plane so as to capture an image including the user's wrist and hand. FIG. 27 is a schematic diagram for explaining the contents of processing of a control device 1 according to the sixth modification. With reference to FIG. 27, processing performed by the image combining unit 13 of the control unit 10 of the control device 1 will be described.

FIG. 27 illustrates a third image 323 generated by the image combining unit 13. The third image 323 in FIG. 27 is an image obtained by combining an image 321 captured by the first sensor 501 in FIG. 26 and an image 322 captured by the second sensor 502 in FIG. 26. In addition, the image 321 and the image 322 are images captured such that the optical axis of the first sensor 501 and the optical axis of the second sensor 502 do not intersect with each other. Therefore, the image combining unit 13 can combine the images acquired from the first sensor 501 and the second sensor 502 installed in the vehicle interior and thereby obtain an image including the user's body and wrist.

### Sixth Embodiment

In the first embodiment described above, the control device 1 generates the third image being an composite image including the user's body and wrist, determines the plurality of first feature points corresponding to the user's body from the third image, and acquires the fourth image including the user's hand by using the second image that corresponds to the plurality of third feature points of the user's wrist. In contrast, in a sixth embodiment, the fourth image including the user's hand is acquired by using the second image that includes the user's wrist without generating the third image being an composite image including the user's body and wrist.

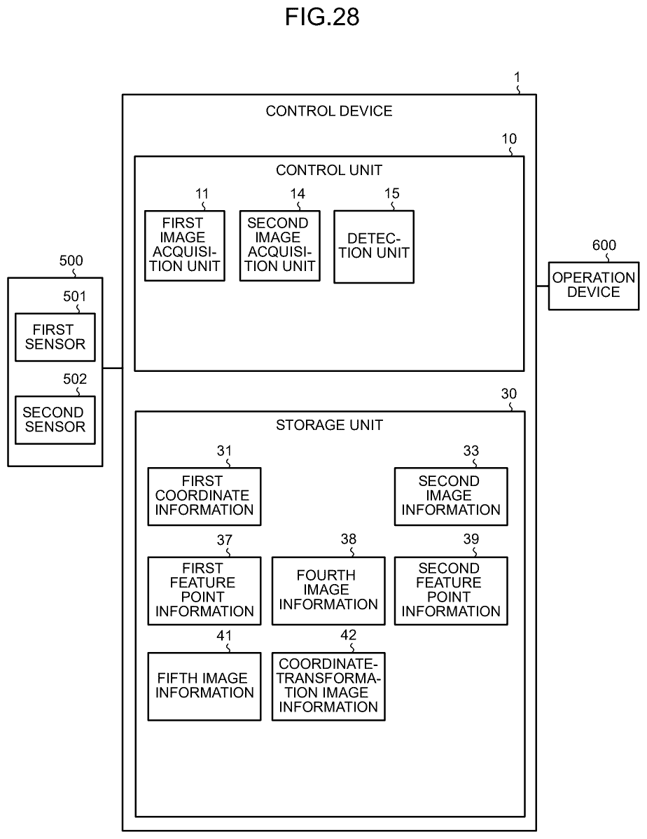

FIG. 28 is a diagram illustrating a schematic configuration of an information system including a control device 1 that is an information processing device according to the sixth embodiment. The information processing device according to the sixth embodiment includes a sensor 500, an operation device 600, and a control device 1. The control device 1 includes a control unit 10 and a storage unit 30. The control unit 10 includes a first image acquisition unit 11, a second image acquisition unit 14, and a detection unit 15. Note that the same contents as those of the first embodiment will not be described.

There is a case where the user's body and wrist are included in an image captured by the first sensor 501. In this case, the control device 1 can determine the wrist of the user from the image including the user's body and wrist. Hereinafter, processing of specific functional units will be described.

The first image acquisition unit 11 acquires a fifth image including the user's body and wrist imaged by the first sensor 501 and the second image including the user's wrist imaged by the second camera.

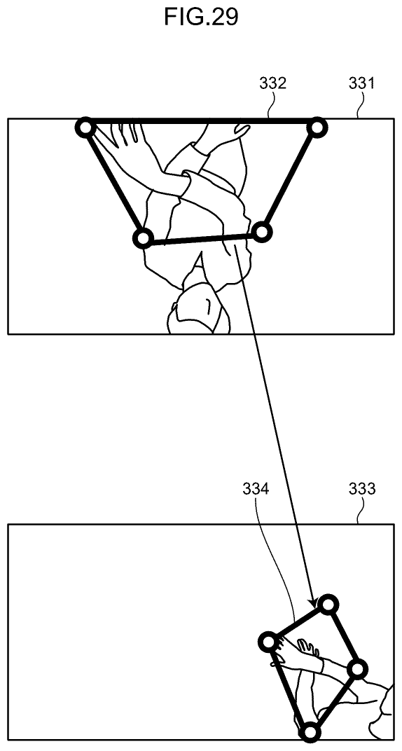

The second image acquisition unit 14 determines a plurality of third feature points corresponding to the wrist from the fifth image, converts the plurality of third feature points into coordinates of the second image, and acquires a fourth image including the hand of the user based on the plurality of third feature points in the second image. Here, the coordinate transformation image will be described with reference to FIG. 29.

FIG. 29 is a schematic diagram for explaining the contents of processing of the control device 1 according to the sixth embodiment. In FIG. 29, a fifth image 331 includes the user's body and wrist imaged by the first sensor 501. Coordinate points 332 at four corners are obtained when the hand is moved to the front left and right and the back left and right. A second image 333 includes the user's wrist imaged by the second camera. Coordinate points 334 at four corners are obtained when the hand is moved to the front left and right and the back left and right.

Although the fifth image 331 includes the user's body and wrist, only part of the user's hand is captured. In other words, the fifth image 331 does not include the entire hand of the user. Therefore, the plurality of second feature points corresponding to the user's hand cannot be determined from the fifth image 331 alone. On the other hand, the second image 333 includes the user's wrist and the user's hand.

The second image acquisition unit 14 determines a plurality of third feature points corresponding to the wrist from the fifth image 331 acquired by the first image acquisition unit 11. In addition, the second image acquisition unit 14 converts the coordinates of the plurality of third feature points of the fifth image 331 into the coordinates of the second image 333 by projective transformation using the coordinate points 332 of the fifth image 331 and the coordinate points 334 of the second image 333. Then, the second image acquisition unit 14 determines a plurality of third feature points in the second image 333, and acquires a fourth image including the hand of the user based on the plurality of third feature points in the second image 333.

With the processing above, when the image acquired by the first image acquisition unit 11 includes the user's body and wrist, the second image acquisition unit 14 can acquire an image including the user's hand from the image captured by the second sensor 502 without combining the images captured by the first sensor 501 and the second sensor 502.

Returning to FIG. 28, the description will be continued. The storage unit 30 stores first coordinate information 31, second image information 33, first feature point information 37, fourth image information 38, second feature point information 39, fifth image information 41, and coordinate-transformation image information 42.

The fifth image information 41 is information including an image including the user's body and wrist captured by the first sensor 501 and a date and time when the first sensor 501 captured the image. The coordinate-transformation image information 42 is information including a coordinate-transformation image that is obtained by performing projective transformation on the fifth image to match with the coordinate system of the second camera by the second image acquisition unit 14.

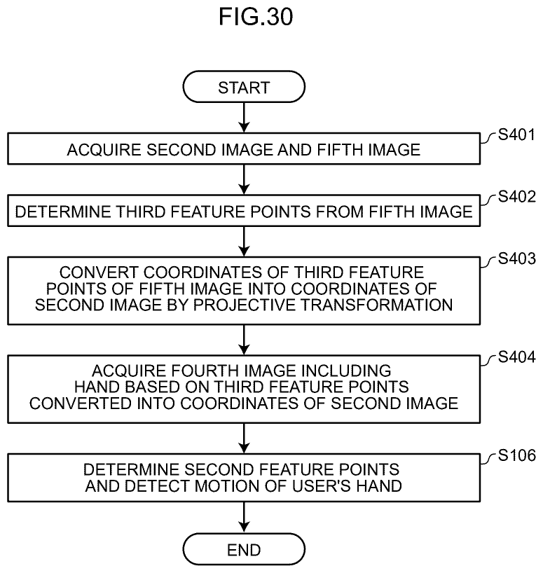

Next, a processing procedure of the control device 1 according to the sixth embodiment will be described with reference to FIG. 30. FIG. 30 is a flowchart illustrating a processing procedure of the control device 1 according to the sixth embodiment. Note that the processing in Step S105 in the flowchart illustrated in FIG. 30 is similar to the processing in Step S105 in the flowchart illustrated in FIG. 10, and thus description thereof is omitted.

In Step S401, the first image acquisition unit 11 acquires the fifth image including the user's body and wrist imaged by the first sensor 501 and the second image including the user's wrist imaged by the second sensor 502 (Step S401). In Step S402, the second image acquisition unit 14 determines a plurality of third feature points corresponding to the wrist from the fifth image 331 acquired by the first image acquisition unit 11 (Step S402).

In Step S403, the second image acquisition unit 14 converts the coordinates of the plurality of third feature points of the fifth image 331 into the coordinates of the second image 333 by projective transformation using the coordinate points 332 of the fifth image 331 and the coordinate points 334 of the second image 333 (Step S403). In Step S404, the second image acquisition unit 14 determines a plurality of third feature points in the second image 333, and acquires a fourth image including the hand of the user based on the plurality of third feature points in the second image 333 (Step S404). When Step S404 ends, the processing of the control device 1 proceeds to Step S106.

As described above, the control device 1 according to one aspect of the present disclosure acquires the fifth image including the user's body and wrist imaged by the first camera and the second image including the user's wrist imaged by the second camera. In addition, the control device 1 determines a plurality of third feature points corresponding to the wrist from the coordinate transformation image. The coordinate transformation image is obtained by performing projective transformation on the fifth image to match with the coordinate system of the second camera, and acquires a fourth image including the hand of the user using the second image corresponding to the plurality of third feature points. Further, the control device 1 determines the plurality of second feature points corresponding to the hand from the fourth image, and detects the motion of the hand based on the plurality of second feature points.

Even when the acquired image includes the user's body alone and does not include the user's hand, the control device 1 determines a plurality of third feature points corresponding to the wrist from the image including the user's body and wrist, acquires an image including the hand of the user from the plurality of determined third feature points, and determines a plurality of second feature points corresponding to the hand of the user from the image including the hand of the user. Therefore, the control device 1 can detect the motion of the hand of the user from the plurality of determined second feature points. Therefore, the control device 1 can improve the accuracy of detecting the motion of the user's hand.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The notation of the “ . . . unit” in the above-described embodiment may be replaced with another notation such as “ . . . circuitry”, “ . . . assembly”, “ . . . device”, “ . . . section”, or “ . . . module”.

In each of the above embodiments, the present disclosure has been described as an example of a configuration using hardware, but the present disclosure can also be implemented by software in cooperation with hardware.

Each functional block used in the description of each embodiment described above is typically implemented as an LSI which is an integrated circuit. The integrated circuit may control each functional block used in the description of the above embodiment and include an input terminal and an output terminal. These may be individually integrated into one chip, or may be integrated into one chip so as to include a part or all of them. Although the LSI is used herein, the LSI may be referred to as an IC, a system LSI, a super LSI, or an ultra LSI depending on the degree of integration.

The circuit integration method is not limited to LSI, and may be implemented using a dedicated circuit or a general-purpose processor and a memory. After manufacturing of the LSI, a field programmable gate array (FPGA) that can be programmed, or a reconfigurable processor in which connections or settings of circuit cells inside the LSI can be reconfigured may be used.

When an integrated circuit technology replacing the LSI appears due to the progress of the semiconductor technology or another derived technology, the functional blocks may be integrated using the technology. Application of biotechnology and the like is possible.

Moreover, the effects of the embodiments described in the present specification are merely examples and are not limited, and other effects may be provided.

### Supplement

The following technical schemes are disclosed by the above description of the embodiments.

### Technical Scheme 1

An information processing device, comprising:
a memory in which a computer program is stored; and
a processor coupled to the memory and configured to perform processing by executing the computer program, the processing including
   acquiring a first image and a second image, the first image including a body of a user captured by a first camera, the second image including a wrist of the user captured by a second camera,
   generating a third image including the body and the wrist of the user by combining the first image and the second image,
   determining a plurality of first feature points corresponding to the body of the user from the third image,
   acquiring a fourth image including a hand of the user based on a third feature point corresponding to the wrist of the user,
   determining a plurality of second feature points corresponding to the hand of the user from the fourth image, and
   detecting a motion of the hand of the user based on the plurality of second feature points.

### Technical Scheme 2

The information processing device according to the technical scheme 1, wherein
the processing further includes converting the first image into a projective transformation image by performing projective transformation on the first image to match with a coordinate system of the second camera, and
the obtaining the third image includes combining the projective transformation image and an optical-axis converted image, the optical-axis converted image being obtained by performing optical-axis conversion on the second image to align the second image with an optical axis of the first camera.

### Technical Scheme 3

The information processing device according to the technical scheme 2, wherein the processing further includes determining the third feature point from the second image when the determining of the plurality of first feature points from the third image is failed.

### Technical Scheme 4

The information processing device according to the technical scheme 3, wherein the processing further includes determining the third feature point corresponding to the wrist from a preset region of the second image.

### Technical Scheme 5

An information processing device, comprising:
a memory in which a computer program is stored; and
a processor coupled to the memory and configured to perform processing by executing the computer program, the processing including
   acquiring a fifth image and a second image, the fifth image including a body and a wrist of the user captured by a first camera, the second image including a wrist of the user captured by a second camera,
   determining a plurality of third feature points corresponding to the wrist of the user from a coordinate transformation image, the coordinate transformation image being obtained by performing a projective transformation on the fifth image to match with a coordinate system of the second camera,
   acquiring a fourth image including a hand of the user based on the second image corresponding to the plurality of third feature points,
   determining a plurality of second feature points corresponding to the hand of the user from the fourth image, and
   detecting a motion of the hand of the user based on the plurality of second feature points.

### Technical Scheme 6

The information processing device according to any one of the technical schemes 1 to 5, wherein the processing further includes correcting a luminance value of the fourth image when the luminance value does not satisfy a predetermined condition.

### Technical Scheme 7

An information processing device, comprising:
a memory in which a computer program is stored; and
a processor coupled to the memory and configured to perform processing by executing the computer program, the processing including
   acquiring an image including a wrist of a user captured by a camera,
   determining a plurality of third feature points corresponding to the wrist of the user from the image including the wrist of the user,
   acquiring image including a hand of the user based on the plurality of third feature points,
   determining a plurality of second feature points corresponding to the hand of the user from the image including the hand of the user, and
   detecting a motion of the hand of the user based on the plurality of second feature points.

### Technical Scheme 8

The information processing device according to the technical scheme 7, wherein the processing further includes, before the acquiring image including the hand of the user, determining the wrist of the user from a preset region of the image including the wrist of the user.

### Technical Scheme 9

The information processing device according to the technical scheme 7 or 8, wherein the processing further includes correcting a luminance value of the image including the hand of the user when the luminance value does not satisfy a predetermined condition.

### Technical Scheme 10

An information processing system, comprising:
a plurality of cameras including a first camera and a second camera; and
the information processing device according to the technical scheme 1.

### Technical Scheme 11

An information processing method, comprising:
acquiring a first image and a second image, the first image including a body of a user captured by a first camera, the second image including a wrist of the user captured by a second camera;
generating a third image including the body and the wrist of the user by combining the first image and the second image;
determining a plurality of first feature points corresponding to the body of the user from the third image;
acquiring a fourth image including a hand of the user based on a third feature point corresponding to the wrist of the user;
determining a plurality of second feature points corresponding to the hand of the user from the fourth image; and
detecting a motion of the hand of the user based on the plurality of second feature points.

### Technical Scheme 12

A computer program executable by a computer, the computer program causing the computer to execute the information processing method according to technical scheme 11.

What is claimed is:

1. An information processing device, comprising:
a memory in which a computer program is stored; and
a processor coupled to the memory and configured to perform processing by executing the computer program, the processing including
acquiring a first image and a second image, the first image including a body of a user captured by a first camera, the second image including a wrist of the user captured by a second camera,
generating a third image including the body and the wrist of the user by combining the first image and the second image,
determining a plurality of first feature points corresponding to the body of the user from the third image,
acquiring a fourth image including a hand of the user based on a third feature point corresponding to the wrist of the user,
determining a plurality of second feature points corresponding to the hand of the user from the fourth image, and
detecting a motion of the hand of the user based on the plurality of second feature points.

2. The information processing device according to claim 1, wherein
the processing further includes converting the first image into a projective transformation image by performing projective transformation on the first image to match with a coordinate system of the second camera, and
the obtaining the third image includes combining the projective transformation image and an optical-axis converted image, the optical-axis converted image being obtained by performing optical-axis conversion on the second image to align the second image with an optical axis of the first camera.

3. The information processing device according to claim 2, wherein the processing further includes determining the third feature point from the second image when the determining of the plurality of first feature points from the third image is failed.

4. The information processing device according to claim 3, wherein the processing further includes determining the third feature point corresponding to the wrist from a preset region of the second image.

5. An information processing device, comprising:
a memory in which a computer program is stored; and
a processor coupled to the memory and configured to perform processing by executing the computer program, the processing including
acquiring a fifth image and a second image, the fifth image including a body and a wrist of the user captured by a first camera, the second image including a wrist of the user captured by a second camera,
determining a plurality of third feature points corresponding to the wrist of the user from a coordinate transformation image, the coordinate transformation image being obtained by performing a projective transformation on the fifth image to match with a coordinate system of the second camera,
acquiring a fourth image including a hand of the user based on the second image corresponding to the plurality of third feature points,
determining a plurality of second feature points corresponding to the hand of the user from the fourth image, and
detecting a motion of the hand of the user based on the plurality of second feature points.

6. The information processing device according to claim 1, wherein the processing further includes correcting a luminance value of the fourth image when the luminance value does not satisfy a predetermined condition.

7. The information processing device according to claim 2, wherein the processing further includes correcting a luminance value of the fourth image when the luminance value does not satisfy a predetermined condition.

8. The information processing device according to claim 3, wherein the processing further includes correcting a luminance value of the fourth image when the luminance value does not satisfy a predetermined condition.

9. The information processing device according to claim 4, wherein the processing further includes correcting a luminance value of the fourth image when the luminance value does not satisfy a predetermined condition.

10. The information processing device according to claim 5, wherein the processing further includes correcting a luminance value of the fourth image when the luminance value does not satisfy a predetermined condition.

11. An information processing device, comprising:
a memory in which a computer program is stored; and
a processor coupled to the memory and configured to perform processing by executing the computer program, the processing including
acquiring an image including a wrist of a user captured by a camera,
determining a plurality of third feature points corresponding to the wrist of the user from the image including the wrist of the user,
acquiring image including a hand of the user based on the plurality of third feature points,
determining a plurality of second feature points corresponding to the hand of the user from the image including the hand of the user, and
detecting a motion of the hand of the user based on the plurality of second feature points.

12. The information processing device according to claim 11, wherein the processing further includes, before the acquiring image including the hand of the user, determining the wrist of the user from a preset region of the image including the wrist of the user.

13. The information processing device according to claim 11, wherein the processing further includes correcting a luminance value of the image including the hand of the user when the luminance value does not satisfy a predetermined condition.

14. The information processing device according to claim 12, wherein the processing further includes correcting a luminance value of the image including the hand of the user when the luminance value does not satisfy a predetermined condition.
